(19) United States
(12) Patent Application Publication
(10) Pub. No.: US 2024/0121580 A1
(43) Pub. Date: Apr. 11, 2024

(54) VOICE AND TEXT COMMUNICATIONS MANAGEMENT RELATED TO ACCESSIBILITY ENHANCEMENT OF A CALLING EXPERIENCE

(71) Applicant: T-MOBILE INNOVATIONS LLC, Overland Park, KS (US)

(72) Inventors: Zaheer Mohammed Siddique, Overland Park, KS (US); Hassan Raza, Overland Park, KS (US)

(21) Appl. No.: 17/963,570

(22) Filed: Oct. 11, 2022

(51) Int. Cl. H04W 4/16; H04M 1/7243

(52) U.S. Cl. CPC H04W 4/16; H04M 1/7243; H04M 1/72475

(57) ABSTRACT

Systems and methods herein improve management of voice and text communications to enhance accessibility. A calling preference configuration of a user device serves as the basis for processing communications that are incoming to, or outgoing from, the user device. The communications can be processed according to the configuration of the calling preference before the communications are received by a user of the user device or transmitted to another user device. The calling preference configuration may be configured by the user and include a sending preference, a receiving preference, and/or a language preference.

### SUMMARY

The present disclosure is directed, in part, to systems and methods for managing voice and text communications on a wireless communications network to enhance accessibility.

According to various aspects of the technology, incoming or outgoing communications to, or from, a user equipment (UE) is managed according to a calling preference configuration of the UE to enhance user accessibility. When a person has a disability or special needs that limit their ability to make a call, they may be required to take multiple additional steps to complete a single call. Even after taking these additional steps, many incoming calls are still not answerable because they don't fulfill the necessary accessibility criteria. Additionally, the existing options in the accessibility space have fixed communication modes for their sending and receiving options. To provide enhanced accessibility for users on a wireless communications network, a calling preference configuration of a UE serves as the basis for managing voice and text communications. This way, if the user has special needs, they may still operate the UE to make calls in parity with other users.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Illustrative embodiments of the present invention are described in detail below with reference to the attached drawing figures, and wherein:

FIG. 1 depicts an exemplary wireless telecommunications network, according to an implementation of an embodiment of the present invention;

FIG. 2 depicts a flowchart of an exemplary method for voice and text communications management in accordance with embodiments of the present invention;

FIG. 3 depicts a flowchart of another exemplary method for voice and text communications management in accordance with embodiments of the present invention;

FIG. 4 depicts a flowchart of another exemplary method for voice and text communications management in accordance with embodiments of the present invention; and

FIG. 5 depicts a block diagram of an exemplary computing environment suitable for use in implementing embodiments herein.

### DETAILED DESCRIPTION

The subject matter of embodiments of the invention is described with specificity herein to meet statutory requirements. However, the description itself is not intended to limit the scope of this patent. Rather, the inventor has contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

By way of background, accessibility of wireless communication networks by users with a disability or special needs has been limited. For example, there is not a ‘one common mode’ for all types of calls that can handle the various situations that arise when a special needs user needs to make or answer a call. Additionally, even mix-and-matching currently available call modes such as a Real-Time Text (RTT) call mode and a Teletypewriter (TTY) call mode does not result in capabilities to handle all situations, notwithstanding the hurdles in achieving interoperability between the two technologies. These hurdles are partially due to TTY operating on the public switched telecommunications network (PSTN) while RTT is IP-based (e.g., IME, LTE, 5G). In situations when there are no interoperability issues, multiple scenarios still exist where successful communication in a call fails. For example, a hard-of-hearing special needs user may make a call using TTY to a hearing user who answers but does not recognize the tones they hear (or other indicator) as an invitation to initiate text communications. The amount of possible scenarios where successful communication is not achieved increases when the call is between a hard-of-hearing special needs user and a visually-impaired special needs user. While conventional workarounds (e.g., interoperability between TTY and RTT) or special services (e.g., relay services) have provided some expanded access for special needs users, the ability to have successful communication is still not in parity with other users. Not only do special needs users need to navigate complex workarounds to make or answer a call, there are still situations where incoming calls are not answerable because they don't fulfill accessibility criteria.

In order to solve this problem, the present disclosure is directed to systems, methods, and computer-readable media for voice and text communications management related to accessibility enhancement of the calling experience. Part of the inventive solution includes having one common mode for all types of calls. Whether this is accomplished on a UE, by the network provider, or a combination thereof, a special needs user is empowered to communicate in their preferred manner. The special needs user will be empowered to set a calling preference once to have their incoming or outgoing calls managed to enhance their accessibility. Within the calling preference option, a preference for voice and text communications can be further customized. For example, a hard-of-hearing special needs user may select a preference for text as the receiving medium and a preference for voice as the sending medium. Without additional cooperation with the other device in the call (or any UE), the hard-of-hearing special needs user will be able to have incoming voice communications converted to text and outgoing text communications converted to voice. In this way, the user may successfully communicate without the other party ever being aware that they were communicating with a special needs user. Providing such accessibility to special needs users will drastically reduce the stress and effort required to make calls as well as decrease the number of failed communication attempts experienced.

Accordingly, a first aspect of the present disclosure is directed to a method for managing voice and text communications during a call, the method comprising determining the calling preference configuration of a first UE during a call between the first UE and a second UE, and the calling preference configuration comprising one or more of a sending preference and a receiving preference. The method further comprises processing, at the first UE, a communication that is incoming to, or outgoing from, the first UE based on the determined calling preference configuration of the first UE. The method further comprises receiving or transmitting, at the first UE, the processed communication based on the determined calling preference configuration of the first UE.

A second aspect of the present disclosure is directed to a method for managing voice and text communications during a call, the method comprising determining, at a first UE, a calling preference configuration of a second UE during a call that includes the first UE and the second UE, and the calling preference configuration comprising one or more of a sending preference and a receiving preference. The method further comprises processing, at the first UE, an outgoing communication from the first UE based on the determined calling preference configuration of the second UE. The method further comprises transmitting the processed communication to the second UE.

A third aspect of the present disclosure is directed to a system for managing voice and text communications during a call, the system comprising a mobile communications network that includes one or more wireless communication technologies. The system further comprising at least one node configured to provide access to the mobile communications network and a calling preference manager configured to determining calling preference configuration of at least one of a first UE and a second UE during a call that includes the first UE and the second UE, the calling preference configuration comprising one or more of a sending preference and a receiving preference. The calling preference manager is further configured to determine a call flow between the first UE and the second UE based on the determined calling preference configuration of at least one of the first UE or the second UE. The calling preference manager is further configured to coordinate the processing of communications between the first UE and the second UE based on the determined call flow.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media include both volatile and nonvolatile media, removable and nonremovable media, and contemplate media readable by a database, a switch, and various other network devices. Computer-readable media includes media implemented in any way for storing information. Examples of stored information include computer-useable instructions, data structures, program circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, as well as removable and non-removable media. By way of example, and not limitation, computer-readable media may include computer storage media and communication media.

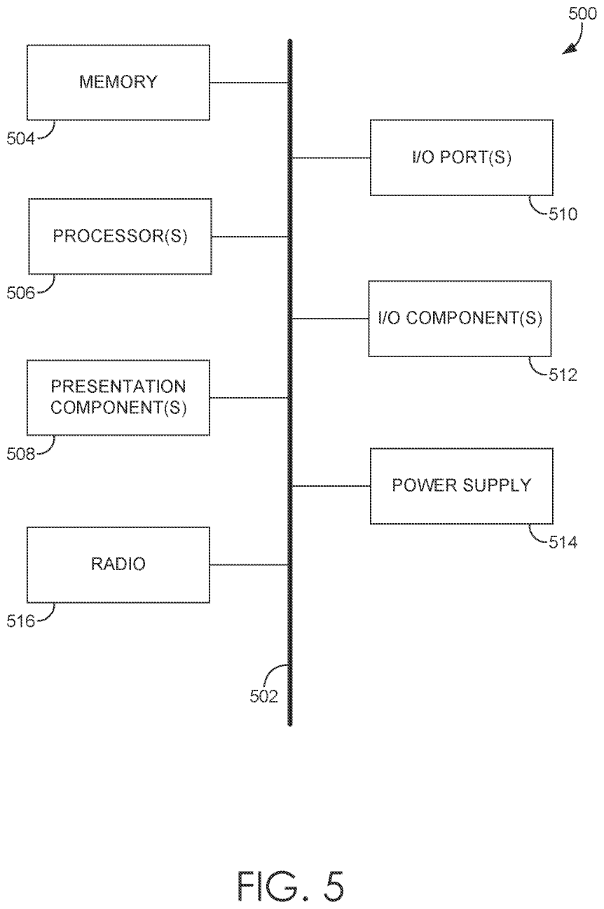

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random-Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 500 shown in FIG. 5. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

A “network” refers to a network comprised of wireless and wired components that provide wireless communications service coverage to one or more user equipment. The network may comprise one or more base stations, one or more cell sites (i.e., managed by a base station), one or more cell towers (e.g., having an antenna) associated with each base station or cell site, a gateway, a backhaul server that connects two or more base stations, a database, a power supply, sensors, and other components not discussed herein, in various embodiments.

The terms “base station” and “cell site” may be used interchangeably herein to refer to a defined wireless communications coverage area (e.g., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, mMIMO (massive multiple-input/multiple-output)) as discussed herein.

The terms “user equipment,” “UE,” and/or “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, UE may take on any variety of devices, such as a personal computer, a laptop computer, a tablet, a netbook, a mobile phone, a smart phone, a personal digital assistant, a wearable device, a fitness tracker, or any other device capable of communicating using one or more resources of the network. UE may include components such as software and hardware, a processor, a memory, a display component, a power supply or power source, a speaker, a touch-input component, a keyboard, and the like. In embodiments, some of the UE discussed herein may include current UE capable of using 5G and having backward compatibility with prior access technologies (e.g., Long-Term Evolution (LTE)), current UE capable of using 5G and lacking backward compatibility with prior access technologies, and legacy UE that is not capable of using 5G.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such. Along similar lines, certain UE are described herein as being “priority” UE and non-priority UE, but it should be understood that in certain implementations UE may be distinguished from other UEs based on any other different or additional features or categorizations (e.g., computing capabilities, subscription type, and the like).

The terms “servicing” and “providing signal coverage,” “providing network coverage,” and “providing coverage,” are interchangeably used to mean any (e.g., telecommunications) service(s) being provided to user devices. Moreover, “signal strength”, “radio conditions,” “level of coverage,” and like, are interchangeably used herein to refer to a connection strength associated with a user device. For example, these terms may refer to radio conditions between a user device and a beam providing coverage to the user device. In particular, the “signal strength,” “level of coverage,” and like may be expressed in terms of synchronization signal (SS) measurements/values and/or channel state information (CSI) measurements/values. In the context of 5G, signal strength may be measured by user devices, which may communicate the signal strength to the cell site and/or the beam management system disclosed herein. In particular, a user device may report various measurements. For example, a user device may provide signal strength as certain synchronization signal (SS) measurements, such as a SS reference signal received power (SS-RSRP) value/measurement, a SS Reference Signal Received Quality (SS-RSRQ) value/measurement, a SS signal-to-noise and interference ratio (SS-SINR) value/measurement, and/or the like. Alternatively or additionally, in some embodiments, signal strength may also be measured and provided in terms of channel state information (CSI) values.

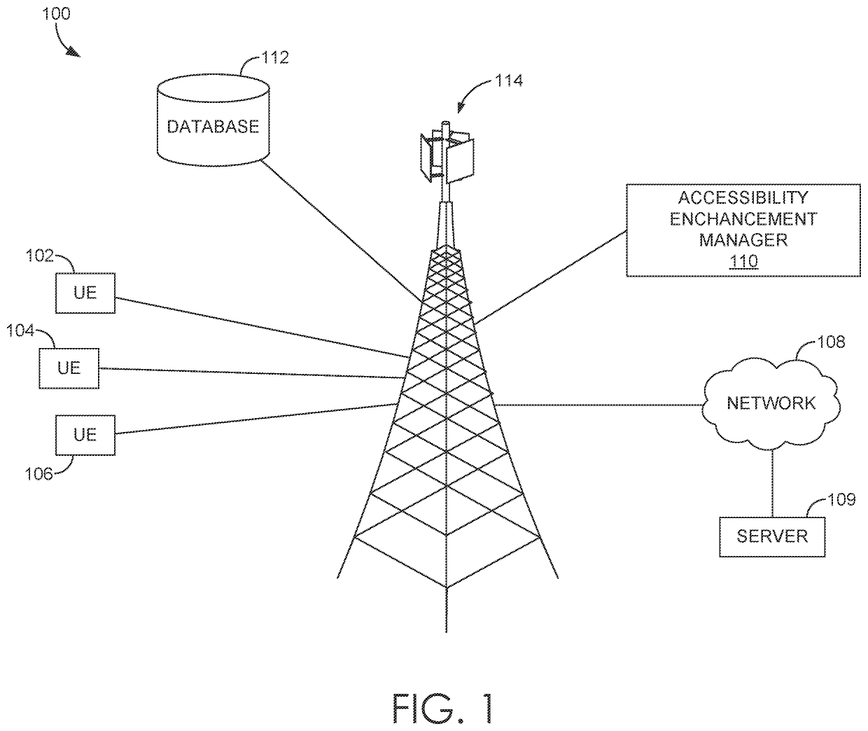

Referring to FIG. 1, an exemplary network environment suitable for use in implementing embodiments of the present disclosure is provided. Such a network environment as illustrated in FIG. 1 is designated generally as network environment 100. Network environment 100 is simplified to illustrate devices, components, and modules in merely one of many suitable configurations and arrangements, such that configurations and arrangements of devices, components, and modules relative to one another, as well as the and the quantity of each of the devices, components, and modules, can vary from what is depicted (e.g., devices, components, and modules may be omitted and/or could be greater in quantity than shown). As such, the absence of components from FIG. 1 should be not be interpreted as limiting the present invention to exclude additional components and combination(s) of components. Similarly, the computing environment 100 should not be interpreted as imputing any dependency between devices, components, and modules, and nor imputing any requirements with regard to each of the devices, components, modules, and combination(s) of such, as illustrated in FIG. 1. Also, it will be appreciated by those having ordinary skill in the art that the connections illustrated in FIG. 1 are also exemplary as other methods, hardware, software, and devices for establishing a communications link between the components, devices, systems, and entities, as shown in FIG. 1, may be utilized in implementation of the present invention. Although the connections are depicted using one or more solid lines, it will be understood by those having ordinary skill in the art that the exemplary connections of FIG. 1 may be hardwired or wireless, and may use intermediary components that have been omitted or not included in FIG. 1 for simplicity's sake.

Network environment 100 includes user devices 102, 104, and 106, access point 114 (which may be a cell site, node, base transceiver station (also known as a base station), communication tower, a small cell, or the like), network 108, server 109, calling preference manager 110, and database 112. In network environment 100, user devices can take on a variety of forms, such as a personal computer (PC), a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the server 109 or the computing device 500 of FIG. 5) that communicates via wireless communications with the access point 114 in order to interact with a public or private network. In this regard, the user device can be any mobile computing device that communicates by way of a wireless network, for example, a 1× circuit voice, a 3G network (e.g., CDMA, CDMA2000, WCDMA, GSM, UMTS), a 4G network (WiMAX, LTE, HSDPA), a 5G network, or any other type of network.

In some cases, the user devices 102, 104, and 106 in network environment 100 can optionally utilize network 108 to communicate with other computing devices (e.g., a mobile device(s), a server(s), a personal computer(s), etc.) through access point 114. The network 108 may be a telecommunications network(s), or a portion thereof. A telecommunications network might include an array of devices or components (e.g., one or more base stations), some of which are not shown. Those devices or components may form network environments similar to what is shown in FIG. 1, and may perform methods in accordance with the present disclosure. Components, such as terminals, links, and nodes (as well as other components) can provide connectivity in various implementations. Network 108 can include multiple networks, as well as being a network of networks, but is shown in more simple form so as to not obscure other aspects of the present disclosure.

Continuing, network 108 can be part of a telecommunication network that connects subscribers to their immediate service provider. In some instances, network 108 can be associated with a telecommunications provider that provides services to user devices 102, 104, and 106. For example, network 108 may provide voice, SMS, video, or data services to user devices corresponding to users that are registered or subscribed to utilize the services provided by a telecommunications provider. Similarly, network 108 may provide services to user devices that correspond to relays, fixed sensors, internet of things (IoT) enabled devices, or any other device that provide connectivity or data to other devices. Network 108 can comprise any communication network providing voice, SMS, and/or data service(s), such as, for example, a 1× circuit voice, a 3G network (e.g., CDMA, CDMA2000, WCDMA, GSM, UMTS), a 4G network (WiMAX, LTE, HSDPA), a 5G network, or a 6G network. In aspects, the network 108 may enable communication over both TDD and FDD technology.

Generally, access point 114 is configured to communicate with user devices, such as user devices 102, 104, and 106 that are located within the geographical area, or cell, covered by radio antennas of a cell site (i.e. access point 114). Access point 114 can include one or more base stations (such as an eNodeB or gNodeB), base transmitter stations, radios, antennas, antenna arrays, power amplifiers, transmitters/receivers, digital signal processors, control electronics, GPS equipment, and the like. Access point 114 can include a wireless communications station that is installed at a fixed location, (e.g., a telecommunication tower) or a mobile base station (e.g., small cell) in some embodiments. In some embodiments, access point 114 also includes or is associated with an LTE System Manager (LSM) configured to manage a master list (e.g., a table) of amplitude weights. The list of amplitude weights may include a plurality of amplitude, phase, and power weights applicable to a plurality of antennas, antenna model numbers, radios, tilt angles of antennas, and the like. The listing may also include amplitude, phase, and power weights applicable to various broadcast configurations, such as multi-beam or unified beam.

Illustrative wireless telecommunications technologies include CDMA, CDMA2000, GPRS, TDMA, GSM, WCDMA, UMTS, and the like. A radio might additionally or alternatively facilitate other types of wireless communications including Wi-Fi, WiMAX, LTE, 5G, or other VoIP communications. As can be appreciated, in various embodiments, the radio can be configured to support multiple technologies and/or multiple radios can be utilized to support multiple technologies.

The back-end system can include one or more computing devices or servers 108, which are connected to the RAN. For example, machine-learning algorithms can be leveraged to identify patterns and predict changes in the network environment, including movement patterns of UEs. Machine learning algorithms include Regression algorithms, Instance-Based algorithms, Regularization algorithms, Decision Tree algorithms, Bayesian algorithms, Clustering algorithms, Association Rule Learning algorithms, Artificial Neural Network algorithms, Deep Learning algorithms, Dimensionality Reduction algorithms, Ensemble algorithms, to name a few.

Calling Preference Manager 110 may exist as a standalone component or may be integrated with another component in network environment 100. The location of Calling Preference Manager 110 within network environment 100 is not important as long as it can perform its intended functions.

In order to enhance accessibility of a calling experience, communications (e.g., text and voice) are processed based on a calling preference configuration of a UE during a call. For example, in one embodiment, Calling Preference Manager 110 may exist as a component (e.g., application) and perform its functions on the UE during the call. A calling preference configuration, which may be a settings option on the UE, may be determined by Calling Preference Manager 110 so that communications that are incoming to, or outgoing from, the UE may be processed by Calling Preference Manager 110 based on the calling preference configuration of the UE. After Calling Preference Manager 110 has processed the communications based on the calling preference of the UE, the processed communications may be received (e.g., presented to the user as text and/or voice) or transmitted (e.g., communicated to another UE). Handling (e.g., processing) communications locally on the UE provides some advantages. For example, a special needs user is not dependent on the network provider or other participants in the call to help ensure successful communication because all operations are handled by Calling Preference Manager 110 locally. In some situations, other people on the call may not be aware that they are communicating to someone with special needs. For example, a person who is hard-of-hearing may be able to respond in a voice conversation, in real-time, without any indication to another person (e.g., a prompt to initiate TTY) that they cannot hear the voice of the other person. In another example, a person who is non-speaking may be able to generate a unique voice for which their text communications may be processed into and transmitted to another person. Not only do such aspects of the invention enhance accessibility, they also encourage participation in society by making it easier and providing a greater sense of individuality. Calling Preference Manager 110 performing its function on the UE may also provide better privacy and may help reduce latency.

One aspect of the invention, which may apply to any embodiment, involves determining the calling preference configuration of the UE. The calling preference configuration of the UE may be a setting option on the UE that the user may modify. The user may opt to use a default setting, or the user may select an alternative calling preference configuration. The default calling preference configuration may be voice for receiving and voice for transmitting in addition to a language preference. Any combination discussed may be suitable as a default option. For example, Calling Preference Manager 110 may be installed with any combination of calling preference configurations (e.g., based on user profile information or a preselection by the user during installation) that would become the default setting. In some cases, the default setting may be configured by a manufacturer. In other cases, the calling preference configuration is initially configured based upon answers from a predetermined set of questions. For example, the first time the user interacts with Calling Preference Manager 110, the user may be presented with interactive questions designed to be fully accessible (e.g., utilizing all accessibility features) until an appropriate calling preference configuration can be determined from answers to the questions. This way, Calling Preference Manager 110 may utilize its functions to provide enhanced accessibility for the user to initially configure the calling preference configuration. Answering questions to arrive at the appropriate calling preference configuration may also aid the user in becoming familiar with Calling Preference Manager 110 (e.g., similar to a tutorial). In some situations, Calling Preference Manager 110 may be responsible for determining the calling preference configuration of the UE for each call (e.g., when Calling Preference Manager 110 is responsible for monitoring the calling preference of the UE). In other situations, Calling Preference Manager 110 might be alerted (e.g., triggered to activate) by another component of the UE that determines the calling preference configuration of the UE. For example, if the default calling preference configuration of the UE is voice for receiving and voice for transmitting without any sub-option selections (e.g., how calls are typically made), then Calling Preference Manager 110 might not be alerted because it may have no functions to perform. Calling Preference Manager 110 may be alerted by the reception or processing of any call or may only be alerted by the reception of a specific call type or types (e.g., RTT only or RTT/TTY only). As will be explained further, determining the calling preference configuration of the UE may include different and/or additional steps in embodiments that involve coordination between two or more UEs, or in embodiments where Calling Preference Manager 110 functions apart from the UE (e.g., when the functions of Calling Preference Manager 110 are performed by the network provider).

The calling preference configuration of the UE may comprise one or more of a sending preference, a receiving preference, and a language preference. At a high level, the sending and receiving preferences may include an option for voice and/or text. For example, the sending preference could be for voice and the receiving preference could be for text. In such a situation, the outgoing communications eventually transmitted (e.g., after being processed by Calling Preference Manager 110) may comprise a voice communication to be heard by the other party and the incoming communications eventually received (e.g., after being processed by Calling Preference Manager 110) may comprise a text communication to be read at the UE. However, the sending preference for voice may further comprise an option to use the user's voice or an option to use text as the basis for processing the outgoing communications from the UE. For example, when the sending preference for voice includes a selection to use the user's voice, the user may simply speak. The user's voice communication could be processed and transmitted as spoken by the user, as spoken by a generated voice, or as translated to another language and spoken by a personalized voice (e.g., utilizing a personalized computer-generated voice). Continuing with the example, the incoming communications may be processed and turned into a text communication. The processing of both voice and text communications may include altering characteristics such as the font, size, or spacing of the text to meet the needs of the user. The features and steps described may be performed in real-time during the call.

It may also be possible for the calling preference configuration to include the receiving preference as having a selection for both voice and text. Similarly, the sending preference may also have a selection for both voice and text. For example, a receiving preference for both voice and text could consist of processing the incoming communications and eventually receiving the communications as both voice and text, based on the individual set of parameters selected for each of voice and text within the receiving preference. By making such a selection, a user may hear and read the received processed communications. The text could appear as a caption of the received voice communications as the communications are received. Similarly, when the sending is for both voice and text, the outgoing communications are processed based on the individual set of parameters selected for each of voice and text within the sending preference. As noted previously, the receiving preference and the sending preference may also include a sub-option for a language preference. For the sake of brevity, all possible configurations of the calling preference are not described in detail as individual scenarios but will be apparent from the description of the invention as a whole.

By taking advantage of currently available language processing tools, Calling Preference Manager 110 may also increase accessibility in a global sense by allowing for communication between individuals who do not speak the same language. For example, in a call between an English-only speaking user of the UE having Calling Preference Manager 110 and a Spanish-only speaking party, the UE may have a calling preference configured to have a sending preference that includes a language preference for Spanish and a receiving preference that includes a language preference for English. In such a situation, both individuals may speak and listen in the language they can understand. The other variations described related to the different features that may be selected (e.g., voice and text options) may apply similarly when multiple languages are involved as well.

On top of language processing tools, image processing tools (e.g., object recognition) may further enhance what is accessible in a call using Calling Preference Manager 110. For example, a visually-impaired user may configure their calling preference to have a receiving preference for voice. If the person they are in a call with sends a caption of a Twitter comment, image processing tools may be able to identify the text object and allow for the text of the Twitter comment to be further processed according to the parameters of the user's receiving preference. Ultimately (e.g., after receiving the processed communication), the visually-impaired user may listen to the Twitter comment being read aloud (e.g., by a computer-generated voice) and respond accordingly.

Calling Preference Manager 110 may also manage, or direct the management of, completed calls. For example, Calling Preference Manager 110 could save completed calls such that they are accessible for the user to revisit at a later time. Saving calls (e.g., an interactive call log) may be standard or, to save memory, may appear as an option following the completion of a call. Maintaining an interactive call log may allow the user to not only access the call again (e.g., playback the call as originally processed) but may allow the user to process the call using a new calling preference configuration. This would be beneficial if the user did not happen to have the appropriate calling preference configuration at the time of the call, but wanted to access and understand the communications that occurred during the call. Therefore, Calling Preference Manager 110 may have enhanced accessibility uses beyond processing voice and text communications in real-time during a call according to the calling preference configuration selected by the user.

In another embodiment, the processing of outgoing communications by Calling Preference Manager 110 at the UE (e.g., first UE) is based on a determined calling preference of another UE (e.g., second UE). The processed outgoing communications are then transmitted to the other UE. This embodiment can be implemented using any or all of the components and component interactions previously described. Aside from providing some similar advantages to previously described embodiments, the current embodiment would allow for a user (e.g., of the second UE) to have enhanced accessibility whether or not the Calling Preference Manager 110 on their UE has the full capability to process communications. In such a situation, a version of Calling Preference Manager 110 might exist on the UE (e.g., an old UE with limited processing power) that allows for the calling preference to be selected, but has limited capabilities. There might also be an option for Calling Preference Manager 110 to turn off communication processing while still retaining an active calling preference that can be determined and used as the basis for the processing of communications by other UEs (e.g., first UE). If the processing by Calling Preference Manager 110 would draw too much energy (e.g., a UE operating on limited battery power), individual features (e.g., the sending preference) may be temporarily disabled. Such an embodiment could be useful for services that might engage in prolonged calls with a special needs user, and may wish to handle resource-intensive processing functions (e.g., processing voice to text) on a UE (e.g., first UE) that is well-equipped to handle the resource-intensive processing functions in order to provide a better calling experience for the special needs user. Additionally, option settings (e.g., a processing preference within the calling preference configuration) could exist where a UE (e.g., second UE) indicates that they prefer not to perform resource-intensive processing. That UE (e.g., second UE) could be in a call with another UE (e.g., first UE) that has a processing preference that indicates they are capable and willing to perform the resource-intensive processing. Through Calling Preference Manager 110, the UEs (e.g., first and second UE) will have been able to determine which UE will handle certain processing functions.

In yet another embodiment, Calling Preference Manager 110 may exist as a component of Access Point 114, Network 108, or any other component of the wireless network provider. Calling Preference Manager 110 may be configured to determine the calling preferences of UEs in a call (e.g., first UE and second UE) and process incoming communications for the UEs in the call based on each of their individual calling preferences, or direct another component of the network to perform the processing. After processing, Calling Preference Manager 110 may transmit, or direct the transmissions of, the processed communications to their respective destinations. However, Calling Preference Manager 110 may alternatively be configured to determine the calling preferences of UEs in a call (e.g., first UE and second UE) and coordinate the processing of communications between the UEs in the call (e.g., determining which UE will process the communications and in which way the communications will be processed) based on the calling preferences of the UEs. These embodiments can be implemented using any or all of the components and component interactions previously described. In an embodiment where the processing of communications based on calling preferences of the UEs occurs within Access Point 114, Network 108, or any other component of the wireless network provider, the power sources of the UEs may not be taxed to perform the processing functions. Certain efficiencies may be obtained when implementing such an embodiment. For example, relative to a situation where two individual UEs (e.g., a first UE and a second UE) are both processing the incoming and the outgoing communications according to different calling preference configurations, having Calling Preference Manager 110 performing the processing functions as a component within network 108 may reduce the overall amount of processing that is performed. Instead of a communication from one UE (e.g., first UE) to another UE (e.g., second UE) being processed twice, Calling Preference Manager 110 may process the incoming communications based on the calling preference of the UE that the communication is going to. Additionally, the processing power available to the network provider may be greater than the UEs in the call.

Efficiency advantages are also present in an embodiment where the processing of communications based on the calling preference of the UE (or multiple UEs) is processed at the UE (or multiple UEs), but where Calling Preference Manager 110 determines the calling preference(s) of the one or more UEs and uses the determined calling preference(s) to determine a call flow between the UEs. After a call flow is determined, Calling Preference Manager 110 may coordinate (e.g., provide an instruction or indication to the UEs to carry out the determined call flow) the processing of communications between the UEs. In this way, Calling Preference Manager 110 may determine the call flow with the optimal distribution of processing between the UEs based on at least one or more of their calling preference configurations. A determined call flow may comprise any of the combinations discussed or contemplated with regard to when and where the processes (e.g., processing incoming and outgoing communications) occur. For example, in a call between a first UE and a second UE, a determined call flow may comprise only the first UE performing all communication processing functions (e.g., voice to text) or may comprise both the first UE and the second UE performing a part of the overall required communication processing to satisfy the calling preference of one or both of the UEs.

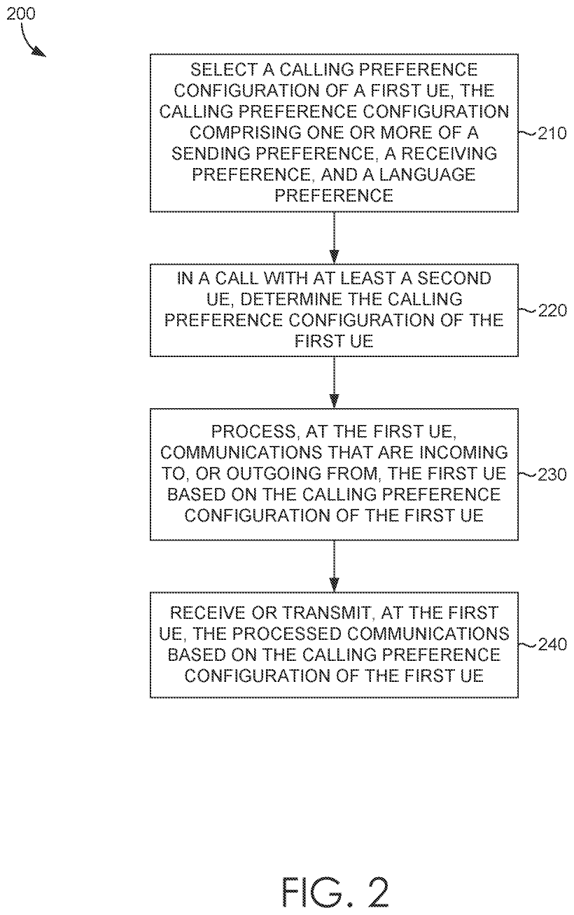

Now referring to FIG. 2, method 200, described herein, can be implemented using any or all of the components and component interactions previously described in FIG. 1. As such, the method is discussed briefly for brevity, though it will be understood that the previous discussion and details described therein can be applicable to aspects of the methods of FIG. 2. Additionally or alternatively, it will be understood that the method discussed herein can be implemented or performed via the execution of computer-readable instructions stored on computer readable media, by one or more processors.

A flow diagram showing a method 200 for managing voice and text communications during a call is provided in accordance with any one or more embodiments of the present disclosure. At block 210, a calling preference comprising one or more of a sending preference, a receiving preference, and a language preference is selected as the calling preference of a first UE. At block 220, the calling preference of the first UE is determined during a call that includes the first UE and a second UE. At block 230, communications that are incoming to, or outgoing from, the first UE are processed at the first UE based on the determined calling preference of the first UE. At block 240, the communications processed based on the calling preference of the first UE are received or transmitted at the first UE.

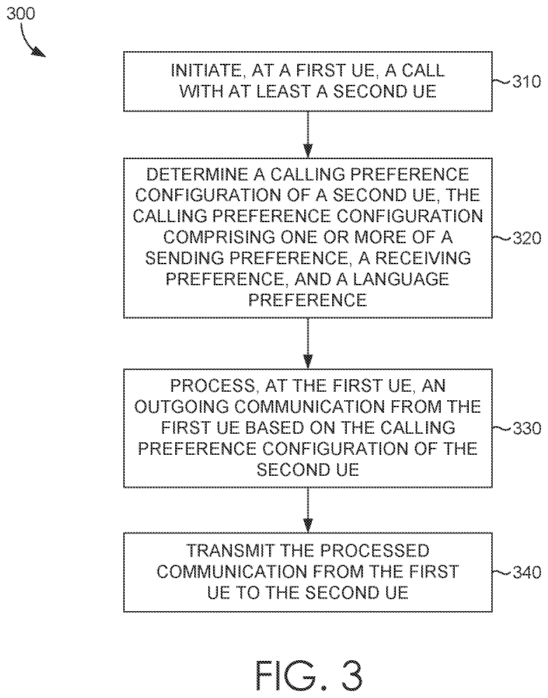

With reference to FIG. 3, method 300, described herein, can be implemented using any or all of the components and component interactions previously described in FIGS. 1 and 2. As such, the method is discussed briefly for brevity, though it will be understood that the previous discussion and details described therein can be applicable to aspects of the methods of FIG. 3. Additionally or alternatively, it will be understood that the method discussed herein can be implemented or performed via the execution of computer-readable instructions stored on computer readable media, by one or more processors.

A flow diagram showing a method 300 for managing voice and text communications during a call is provided in accordance with any one or more embodiments of the present disclosure. At block 310, a call is initiated between a first UE and a second UE. At block 320, a first UE determines the calling preference of a second UE during the call, the calling preference comprising one or more of a sending preference, a receiving preference, and a language preference. At block 330, the first UE processes an outgoing communication from the first UE based on the calling preference of the second UE. At block 340, the processed communication is transmitted from the first UE to the second UE.

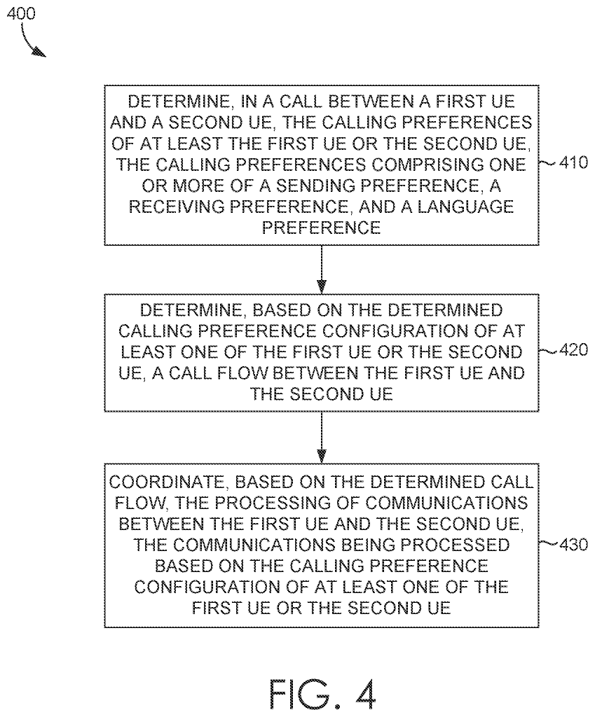

With reference to FIG. 4, method 400, described herein, can be implemented using any or all of the components and component interactions previously described in FIGS. 1-3. As such, the method is discussed briefly for brevity, though it will be understood that the previous discussion and details described therein can be applicable to aspects of the methods of FIG. 4. Additionally or alternatively, it will be understood that the method discussed herein can be implemented or performed via the execution of computer-readable instructions stored on computer readable media, by one or more processors.

A flow diagram showing a method 400 for managing voice and text communications is provided in accordance with any one or more embodiments of the present disclosure. At block 410, a calling preference of at least one of a first UE or a second UE is determined during a call between the first UE and the second UE, the calling preferences comprising one or more of a sending preference, a receiving preference, and a language preference. At block 420, a call flow between the first UE and the second UE is determined based on the determined calling preference configuration of at least one of the first UE or the second UE. At block 430, the processing of communications between the first UE and the second UE is coordinated, wherein the coordination may comprise an instruction or indication to the first and/or second UE for carrying out the determined call flow.

Turning to FIG. 5, computing device 500 includes a bus 502 that directly or indirectly couples the following devices: memory 504, one or more processors 506, one or more presentation components 508, input/output (I/O) ports 510, input/output (I/O) components 512, and an illustrative power supply 514. Bus 502 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterate that the diagram of FIG. 5 is merely illustrative of an example computing device that can be used in connection with one or more embodiments of the present invention. Distinction is not made between such categories as “workstation,” “server,” “laptop,” “handheld device,” etc., as all are contemplated within the scope of FIG. 5 and reference to “computing device.”

Computing device 500 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media is non-transitory. In contrast to communication media, computer storage media is not a modulated data signal or any signal per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 504 includes computer-storage media in the form of volatile and/or nonvolatile memory. The memory may be removable, non-removable, or a combination thereof. Example hardware devices include solid-state memory, hard drives, optical-disc drives, etc. Computing device 500 includes one or more processors that read data from various entities such as memory 504 or 1/O components 512. Presentation component(s) 508 present data indications to a user or other device. Example presentation components include a display device, speaker, printing component, vibrating component, etc.

I/O ports 510 allow computing device 500 to be logically coupled to other devices including I/O components 512, some of which may be built in. Illustrative components include a microphone, joystick, game pad, satellite dish, scanner, printer, wireless device, etc.

Radio 516 represents a radio that facilitates communication with a wireless telecommunications network. Illustrative wireless telecommunications technologies include CDMA, GPRS, TDMA, GSM, W-CDMA, EDGE, CDMA2000, and the like. Radio 516 might additionally or alternatively facilitate other types of wireless communications including Wi-Fi, WiMAX, LTE, 5G, or other VoIP communications. As can be appreciated, in various embodiments, radio 516 can be configured to support multiple technologies and/or multiple radios can be utilized to support multiple technologies.

The invention claimed is:

1. A method for managing voice and text communications during a call, the method comprising:
determining a calling preference configuration of a first UE during a call that includes the first UE and a second UE, wherein the calling preference configuration comprises one or more of a sending preference or a receiving preference;
processing, at the first UE, a communication that is incoming to, or outgoing from, the first UE based on the determined calling preference configuration of the first UE; and
receiving or transmitting, at the first UE, the processed communication based on the determined calling preference configuration of the first UE.

2. The method of claim 1, wherein the calling preference configuration may be accessed as a settings option on the first UE and can be modified by a user of the first UE.

3. The method of claim 1, wherein the calling preference configuration further comprises a language preference.

4. The method of claim 3, wherein the processing of the communication further comprises a translation of voice and text communications into the preferred language.

5. The method of claim 1, wherein the steps of claim 1 are executed by a voice and text communications management application operating on the first UE.

6. The method of claim 1, wherein the calling preference configuration is initially configured based upon answers from a predetermined set of questions.

7. The method of claim 1, wherein the communication is outgoing from the first UE, and wherein the processing of the outgoing communication further comprises processing the outgoing communication to utilize a personalized computer-generated voice.

8. The method of claim 1, wherein the processing of the communication further comprises altering characteristics such as a font, a size, or a spacing of any text.

9. The method of claim 1, further comprising saving a completed call in an interactive call log.

10. The method of claim 1, wherein the calling preference configuration further comprises a processing preference.

11. The method of claim 1, wherein the receiving preference comprises a selection for both voice and text.

12. The method of claim 11, wherein the communication is incoming to the first UE, and wherein receiving the processed incoming communication further comprises receiving a voice message that is captioned with text.

13. A method for managing voice and text communications during a call, the method comprising:
determining a calling preference configuration of a second UE during a call that includes the first UE and the second UE, wherein the calling preference configuration comprises one or more of a sending preference or a receiving preference;
processing, at the first UE, an outgoing communication from the first UE based on the determined calling preference configuration of the second UE; and
transmitting the processed communication to the second UE.

14. The method of claim 13, wherein the calling preference configuration further comprises a language preference.

15. The method of claim 13, wherein the steps of claim 13 are executed by a voice and text communications management application operating on the first UE.

16. The method of claim 13, wherein the processing of the outgoing communication further comprises processing the outgoing communication to utilize a personalized computer-generated voice.

17. A system for managing voice and text communications during a call, the system comprising:
a mobile communications network;
at least one node configured to provide access to the mobile communications network; and
a calling preference manager configured to:
determining a calling preference configuration of at least one of a first UE or a second UE during a call that includes the first UE and the second UE, the calling preference configuration comprising one or more of a sending preference and a receiving preference;
based on the determined calling preference configuration of at least one of the first UE or the second UE, determining a call flow between the first UE and the second UE; and
based on the determined call flow, coordinating the processing of communications between the first UE and the second UE, the communications being processed based on the calling preference configuration of at least one of the first UE or the second UE.

18. The method of claim 17, wherein the calling preference configuration further comprises a language preference.

19. The method of claim 17, further comprising saving a completed call in an interactive call log.

20. The method of claim 17, wherein the calling preference configuration of the first UE has a receiving preference for voice, and wherein the processing of the incoming communication to the first UE further comprises processing the outgoing communication to utilize a personalized computer-generated voice.
